(19) United States
(12) Patent Application Publication
(10) Pub. No.: US 2019/0227241 A1
(43) Pub. Date: Jul. 25, 2019

(54) LIGHT-SHIELDING FIBER OPTIC CONNECTOR

(71) Applicant: SOLTEAM OPTO, INC., Taoyuan City (TW)

(72) Inventors: Chin-Feng CHEN, Taoyuan City (TW); Po-Kai WANG, Taoyuan City (TW); Chang-Ming LEE, Taoyuan City (TW)

(21) Appl. No.: 16/150,985

(22) Filed: Oct. 3, 2018

(30) Foreign Application Priority Data
Jan. 22, 2018 (TW) 107102241

(51) Int. Cl. G02B 6/38; G02B 6/42

(52) U.S. Cl. CPC G02B 6/3833; G02B 6/4201; G02B 6/3897

(57) ABSTRACT

A light-shielding fiber optic connector includes a housing defining therein a mating-connection chamber, a mating-connection portion at one side of the mating-connection chamber, an accommodation chamber at an opposite side of the mating-connection chamber and a plug hole perpendicularly connected to the mating-connection chamber, an optical device mounted in the accommodation chamber with a light source transceiver thereof facing toward the mating-connection chamber, a light-shielding device mounted in the plug hole and providing a flexible light-shielding portion for blocking between the mating-connection chamber and the accommodation chamber to prevent light leakage and to prohibit external dust from contaminating the optical device, and a position-limiting member mounted to the housing to hold down the light-shielding device in the plug hole.

This application claims the priority benefit of Taiwan patent application number 107102241, filed on Jan. 22, 2018.

### BACKGROUND OF THE INVENTION

### 1. Field of the Invention

The present invention relates to fiber optic technology and more particularly, to a light-shielding fiber optic connector, which prevents light leakage and prohibits external dust from contaminating a light source transceiver of the optical device.

### 2. Description of the Related Art

With the ever-changing communications technology and the use of telephones, networks and other communications equipment, the distance between people is getting closer and closer. A communication equipment uses a cable to transmit electrical signal or optical signal. For optical signal transmission, fiber optic cable is an optical signal transmission medium that achieves fastest transmission. Optical fiber is made of non-metal materials such as plastic or glass. For the advantages of excellent electromagnetic resistance and anti-interference capabilities, high bandwidth, light weight, long signal transmission distance and good confidentiality, making the optical fiber, optical fiber is widely used to replace traditional metal transmission lines.

At present, there are various optical fiber connectors available on the market for use in electrical and electronic devices such as televisions, stereos, speakers, DVD players, audio and video players etc., for the connection of the fiber optic cable. If the power of the electrical or electronic product is turned on before connection of the fiber optic connector, the light source transceiver in the fiber optical connector will emit light toward the user, the surrounding wall, furniture or other objects, causing discomfort to the user.

To prevent light source leakage, a fiber optic connector can be equipped with a light baffle. FIGS. 7 and 8 illustrate a fiber optic connector according to the prior art. As illustrated, the fiber optic connector comprises a first housing A, a second housing B, a dust cover C and an electronic device D. The first housing A comprises two plug plates A1 bilaterally disposed at a top side thereof, two clamping plates A2 bilaterally disposed at a bottom side thereof, and a first accommodation chamber A3 defined between the two clamping plates A2. The second housing B comprises a second accommodation chamber B1, two mounting grooves B2 symmetrically disposed at two opposite lateral sides thereof relative to the second accommodation chamber B1, a top opening B3 disposed above the mounting groove B2, and two guide grooves B4 horizontally defined therein at two opposite sides. The dust cover C comprises two pivot pins C1 symmetrically disposed at two opposite sides thereof and respectively loaded with a respective torsion spring C2.

In installation, the dust cover C is inserted into the second accommodation chamber B1 of the second housing B, and then the pivot pins C1 of the dust cover C are respectively coupled to the guide grooves B4 of the second housing B, and then the electronic device D is inserted into the first accommodation chamber A3 of the first housing A, and then the first housing A is attached to the second housing B with the plug plates A1 respectively inserted into the guide grooves B4 and stopped against the respective pivot pins C1 of the dust cover C and the clamping plates A2 respectively hooked in the respective mounting grooves B2 of the second housing B. Thus, the electronic device D is held between the first housing A and the second housing B. Further, electrical pins E are mounted in the bottom side of the second housing B for bonding to an external circuit board.

According to this prior art design of fiber optic connector, two different molds must be used for making the first housing A and the second housing B; the plug plates A1 of the first housing A are respectively inserted into the guide grooves B4 of the second housing B to stop the respective pivot pins C1 of the dust cover C in position. The preparation of the dust cover C, the first housing A and the second housing B is complicated and expensive. When the fiber optic connector is not in operation, the light emitted by the electronic device D can leak out of the fiber optic connector through gaps around the dust cover C to project onto human body and other surrounding objects. During application of the fiber optic connector, the inserted fiber optic cable with the attached fiber optic lead end connector will bias the dust cover C in the second housing B to force the dust cover C into abutment against an inner top wall of the second housing B. At this time, external light can go through the gap around the fiber optic lead end connector into the inside of the second housing B to interfere with the signal transmission of the electronic device D. Therefore, this prior art fiber optic connector has the drawbacks of complicated and expensive manufacturing process, optical leakage, external light interference and optical signal transmission instability. There is a strong demand for a fiber optic connector that eliminates the drawbacks of the aforesaid prior art fiber optic connector.

### SUMMARY OF THE INVENTION

The present invention has been accomplished under the circumstances in view. It is therefore the main object of the present invention to provide a light-shielding fiber optic connector, which prevents light leakage and prohibits external dust from contaminating the light source transceiver of the optical device.

To achieve this and other objects of the present invention, a light-shielding fiber optic connector comprises a housing, an optical device, a light-shielding device and a position-limiting member. The housing comprises a mating-connection chamber, a mating-connection portion located at one side of the mating-connection chamber, an accommodation chamber located at an opposite side of the mating-connection chamber and a plug hole perpendicularly connected to the mating-connection chamber near the accommodation chamber. The optical device is mounted in the accommodation chamber, comprising the light source transceiver facing toward the mating-connection chamber and a plurality of electrical pins extended out of the housing for bonding to an external circuit board. The light-shielding device is mounted in the plug hole of the housing, comprising a flexible light-shielding portion for blocking between the mating-connection chamber and the accommodation chamber. The position-limiting member is mounted to the housing to hold down the light-shielding device in the plug hole.

Preferably, the housing further comprises a connecting bush axially mounted therein in communication between the plug hole and the mating-connection chamber, a docking channel defined in the connecting bush in communication between the mating-connection chamber and the accommodation chamber, and an optical channel of reduced diameter disposed in communication between the docking channel and the accommodation chamber. Further, the inserted length of the connecting bush in the mating-connection chamber is smaller or equal to one half of the length of the mating-connection chamber. Further, the diameter of the optical channel is smaller than or equal to the width of the optical device and greater than or equal to the size of the light source transceiver. Further the diameter of the docking channel is smaller than or equal to the width of the flexible light-shielding portion of the light-shielding device. Further, the diameter of the optical channel is smaller than or equal to the width of the flexible light-shielding portion of the light-shielding device.

Preferably, the light-shielding fiber optic connector further comprises fastening means for fastening the position-limiting member to the housing. The housing further comprises an external locating groove extended around the periphery thereof over the plug hole for the mounting of the position-limiting member. The fastening means comprises a plurality of hook blocks symmetrically protruded from two opposite lateral sides of the periphery of the housing within the external locating groove, and a plurality of hook holes symmetrically located on two opposite lateral sides of the position-limiting member for engagement with the respective hook blocks.

Preferably, the light-shielding fiber optic further comprises an engagement structure for securing the light-shielding device to the housing. The engagement structure comprises a plurality of engagement grooves vertically and symmetrically located on two opposite inner sidewalls of the plug hole, and a plurality of engagement rails vertically and symmetrically located on two opposite sides of the light-shielding device for engaging into the respective engagement grooves.

Preferably, the housing further comprises at least one rib located on an inside wall of the accommodation chamber for abutment against the inserted optical device, and a guiding channel cut through a bottom wall thereof in communication with the accommodation chamber for the passing of the electrical pins of the optical device to the outside of the housing.

Preferably, the light-shielding device is selectively made of plastic, silicone or rubber, and the flexible light-shielding portion is selectively made of opaque flexible plastic, silicon rubber or rubber in a width smaller than the width of the light-shielding device. Preferably, the flexible light-shielding portion is integrally formed in the light-shielding device in a crossed shape, star shape or radial configuration and extended through two opposite sides of the light-shielding device so that the light-shielding device is elastically deformable in different directions

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a light-shielding fiber optic connector in accordance with the present invention.

FIG. 2 is an exploded view of the light-shielding fiber optic connector in accordance with the present invention.

FIG. 3 corresponds to FIG. 2 when viewed from another angle.

FIG. 4 is a sectional side view of the light-shielding fiber optic connector in accordance with the present invention.

FIG. 5 is a schematic sectional applied view of the present invention, illustrating the installation of the fiber optic cable with the fiber optic lead end connector in the light-shielding fiber optic connector (I).

FIG. 6 is a schematic sectional applied view of the present invention, illustrating the installation of the fiber optic cable with the fiber optic lead end connector in the light-shielding fiber optic connector (II).

FIG. 7 is an exploded view of a fiber optic connector according to the prior art.

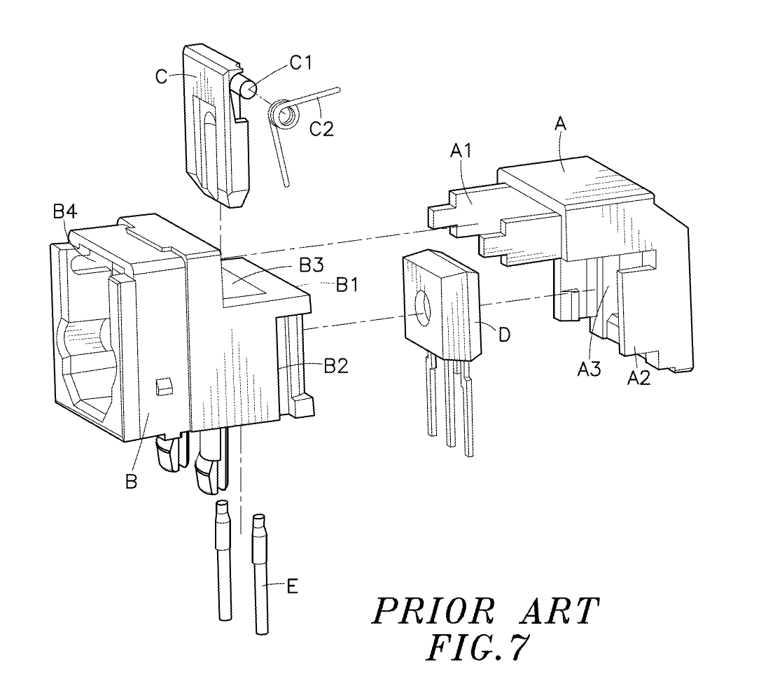

FIG. 8 is a sectional assembly side view of the fiber optic connector according to the prior art.

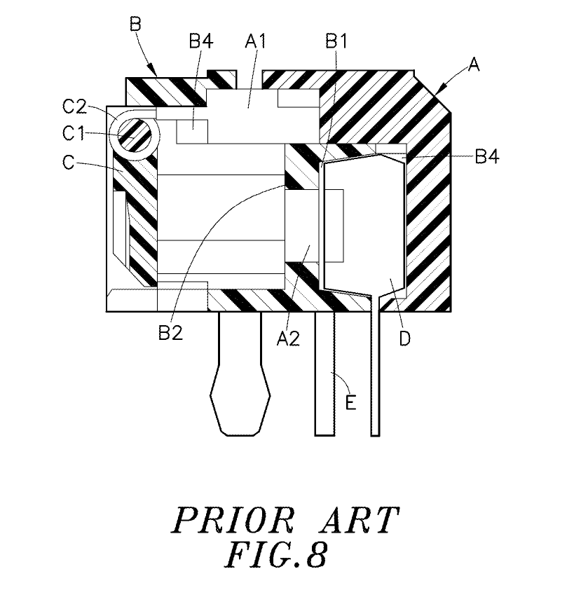

### DETAILED DESCRIPTION OF THE PREFERRED EMBODIMENT

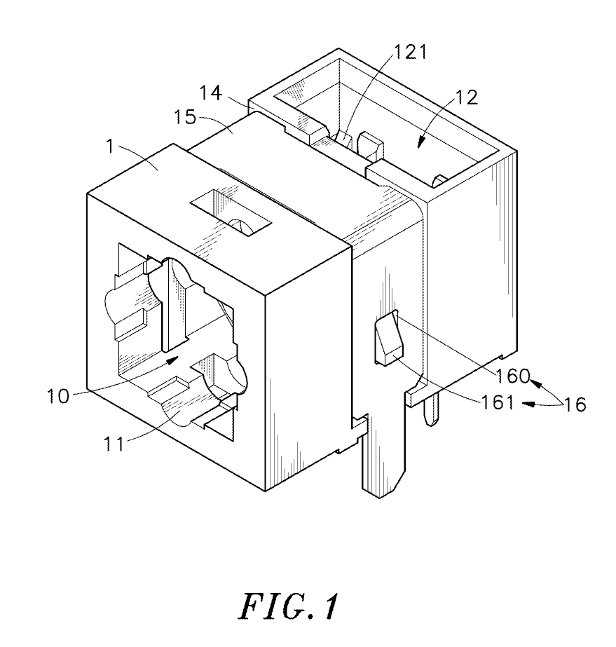

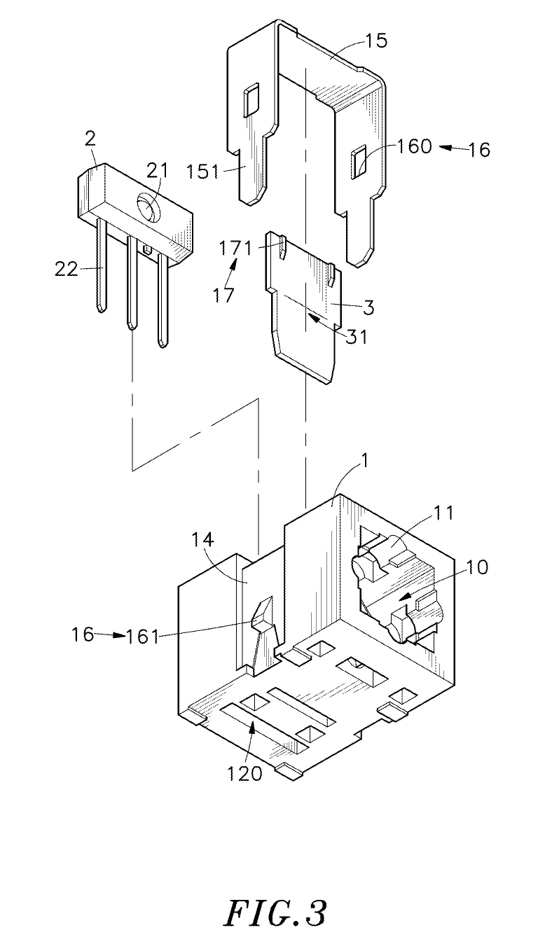

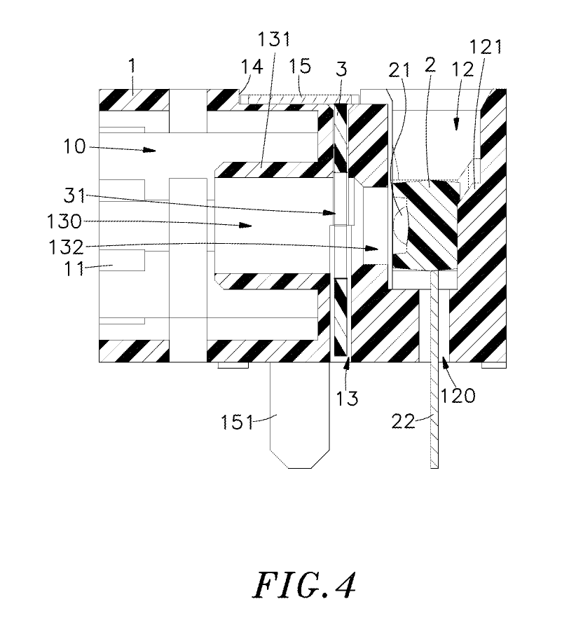

Referring to FIGS. 1-4, an oblique top elevational view of a light-shielding fiber optic connector in accordance with the present invention, an exploded view of the light-shielding fiber optic connector and another exploded view of the light-shielding fiber optic connector are shown. The light-shielding fiber optic connector comprises a housing 1, an optical device 2 and a light-shielding device 3.

The housing 1 comprises a mating-connection chamber 10 defined therein, a mating-connection portion 11 located at one side of the mating-connection chamber 10, an accommodation chamber 12 located at an opposite side of and disposed in communication with the mating-connection chamber 10, a plug hole 13 disposed near the accommodation chamber 12 and connected with the mating-connection chamber 10 at right angles, a connecting bush 131 axially mounted therein in communication between the plug hole 13 and the mating-connection chamber 10, a docking channel 130 defined in the connecting bush 131 in communication between the mating-connection chamber 10 and the accommodation chamber 12, an optical channel 132 of reduced diameter disposed in communication between the docking channel 130 and the accommodation chamber 12, an external locating groove 14 extended around the periphery thereof over the plug hole 13, a position-limiting member 15 detachably mounted in the external locating groove 14, and fastening means 16 to secure the position-limiting member 15 to the external locating groove 14. The position-limiting member 15 is an inverted-U plate, comprising two positioning plug tips 151 respectively extended from two opposite lateral sides thereof and bilaterally suspending outside of a bottom side of the housing 1, The fastening means 16 comprises a plurality of hook blocks 161 symmetrically protruded from two opposite lateral sides of the periphery of the housing 1 within the external locating groove 14, and a plurality of hook holes 160 symmetrically located on the two opposite lateral sides of the position-limiting member 15 and respectively forced into engagement with the respective hook blocks 161.

The optical device 2 comprises a light source transceiver 21 located at a front side thereof, and a plurality of electrical pins 22 downwardly extended from a bottom side thereof.

The light-shielding device 3 can be made of opaque plastic, silicone or rubber, comprising a flexible light-shielding portion 31. The flexible light-shielding portion 31 can be made of flexible opaque plastic, silicon rubber or rubber. Thus, the flexible light-shielding portion 31 can be elastically deformably biased toward two opposite sides of the light-shielding device 3.

In installation, mount the optical device 2 in the accommodation chamber 12 of the housing 1 to keep the light source transceiver 21 in axial alignment with the optical channel 132, the docking channel 130 and the mating-connection chamber 10, and then plug the light-shielding device 3 into the plug hole 13 of the housing 1 to force the flexible light-shielding portion 31 into the space between the optical channel 132 and the docking channel 130. At this time, the flexible light-shielding portion 31 blocks the optical channel 132 to interrupt conduction between the light source transceiver 21 and the docking channel 130. Thereafter, mount the position-limiting member 15 in the external locating groove 14 to hold down the light-shielding device 3 in the plug hole 13 and to force the hook holes 160 of the fastening means 16 into engagement with the respective hook blocks 161. At this time, the position-limiting member 15 is locked to the housing 1 to stop the light-shielding device 3 from falling out of the plug hole 13. Thus, the housing 1, the optical device 2 and the light-shielding device 3 are assembled to constitute the light-shielding fiber optic connector of the present invention.

The housing 1 further comprises at least one rib 121 raised from an inside wall of the accommodation chamber 12 for abutment against the light source transceiver 21 of the inserted optical device 2 to enhance positioning stability of the optical device 2 in the accommodation chamber 12, a guiding channel 120 cut through a bottom wall thereof in communication with the accommodation chamber 12 for the passing of the electrical pins 22 of the inserted optical device 2 to the outside of the housing 1 so that the electrical pins 22 of the inserted optical device 2 can be electrically bonded to an external circuit board using through hole or SMT technology. Further, an engagement structure 17 consisting of engagement grooves 170 and engagement rails 171 is provided to enhance positioning accuracy and stability of the light-shielding device 3 in the plug hole 13. In this embodiment, the engagement grooves 170 are vertically and symmetrically located on two opposite inner sidewalls of the plug hole 13; the engagement rails 171 are vertically and symmetrically located on two opposite sides of the light-shielding device 3 for engaging into the respective engagement grooves 170. After insertion of the light-shielding device 3 into the plug hole 13, the engagement rails 171 are engaged into the respective engagement grooves 170 to secure the light-shielding device 3 firmly in the plug hole 13 with the flexible light-shielding portion 31 blocked between the docking channel 130 and the optical channel 132 to prohibit leakage of light emitted by the light source transceiver 21 into the docking channel 130, the optical channel 132 or the mating-connection chamber 10 of the housing 1 for causing interference.

The flexible light-shielding portion 31 is made of flexible plastic, silicon rubber or rubber and integrally formed in the light-shielding device 3 in a crossed shape, star shape or radial configuration and extended through two opposite sides of the light-shielding device 3 so that the light-shielding device 3 can be elastically deformed in different directions. Further, the width of the light-shielding portion 31 is smaller than the width of the light-shielding device 3.

Further, the inserted length of the connecting bush 131 in the mating-connection chamber 10 is smaller or equal to one half of the length of the mating-connection chamber 10; the diameter of the optical channel 132 is smaller than or equal to the width of the optical device 2 and greater than or equal to the size of the light source transceiver 21; the diameter of the docking channel 130 is smaller than or equal to the width of the flexible light-shielding portion 31 of the light-shielding device 3; the diameter of the optical channel 132 is smaller than or equal to the width of the flexible light-shielding portion 31 of the light-shielding device 3.

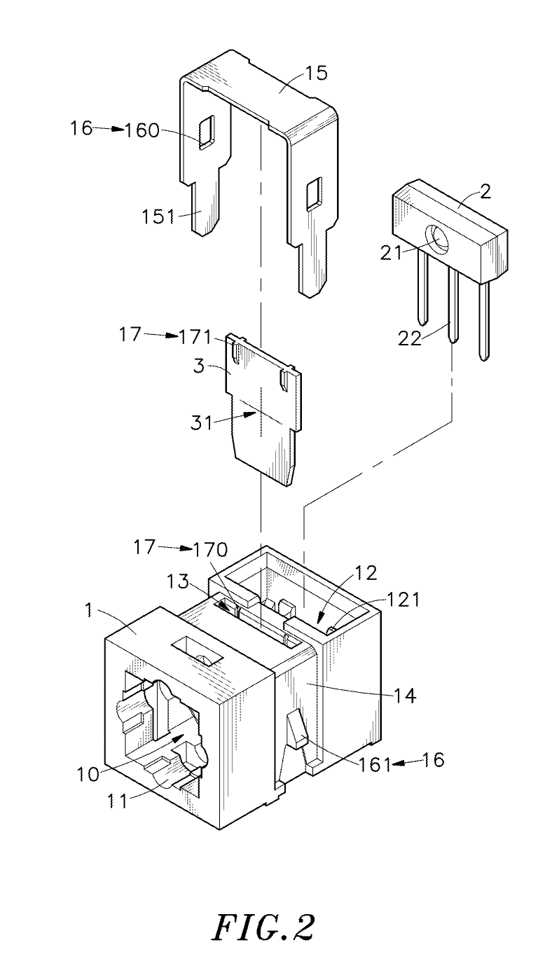

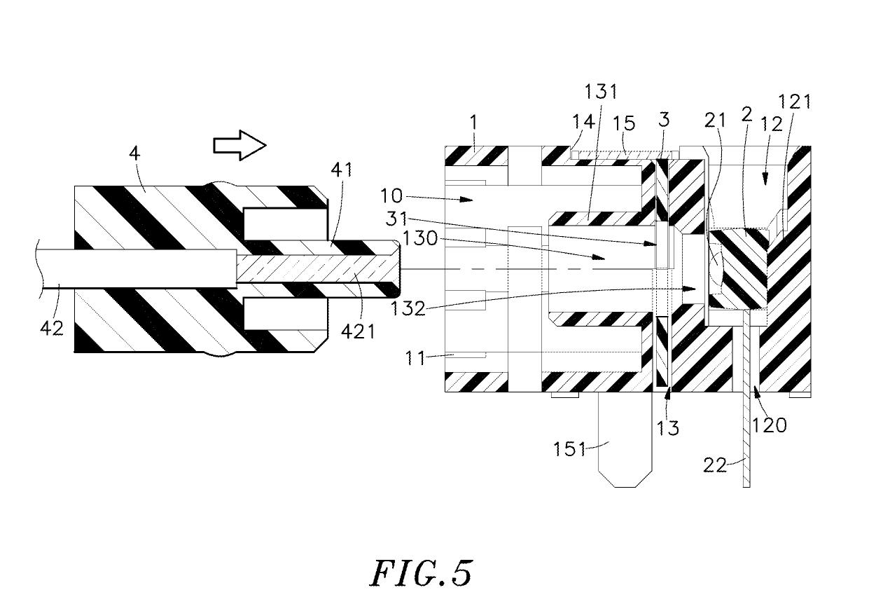

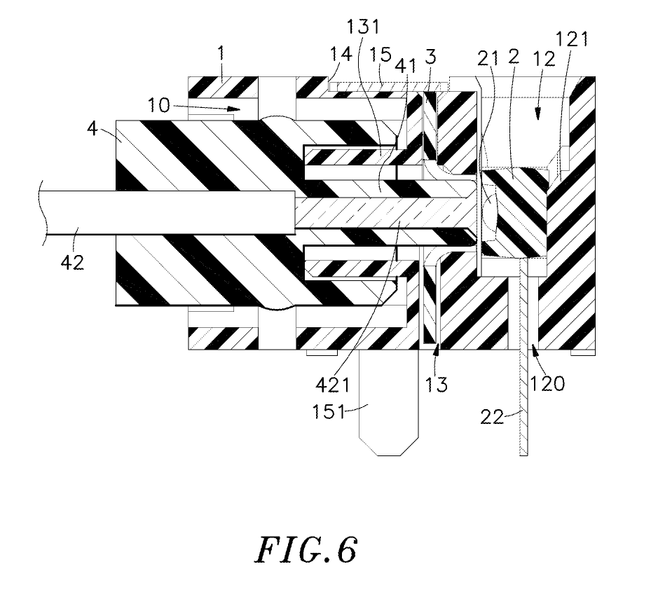

Referring to FIGS. 5 and 6 and FIG. 2 again, in application of the light-shielding fiber optic connector, a fiber optic lead end connector 4 comprising a tubular calibration support 41 is inserted into the mating-connection portion 11 at one side of the mating-connection chamber 10 of the housing 1 to connect a fiber optic cable 42 to the housing 1. The fiber optic cable 42 comprises fiber optic core 421 engaged into the tubular calibration support 41 and exposed to the outside of the distal end (front end) of the tubular calibration support 41. The tubular calibration support 41 of the fiber optic lead end connector 4 is inserted through the mating-connection chamber 10 into the docking channel 130 of the connecting bush 131 to bias the flexible light-shielding portion 31 of the light-shielding device 3 so that the tubular calibration support 41 can be inserted into the optical channel 132. At this time, the flexible light-shielding portion 31 is elastically deformed and retained between the outer perimeter of the tubular calibration support 41 and the inner perimeter of the optical channel 132 to hold down the tubular calibration support 41 in the optical channel 132, thus, the fiber optic core 421 in the tubular calibration support 41 is kept in axial alignment with the light source transceiver 21 of the optical device 2 for allowing transmission of signals between the light source transceiver 21 and the fiber optic core 421. Further, the electrical pins 22 of the optical device 2 are bonded to an external circuit board before insertion of the fiber optic lead end connector 4 into the mating-connection portion 11 to connect the fiber optic cable 42 to the housing 1.

As described above, when the tubular calibration support 41 of the fiber optic lead end connector 4 is inserted into the mating-connection chamber 10 of the housing 1, the tubular calibration support 41 biases the flexible light-shielding portion 31 of the light-shielding device 3. After insertion of the tubular calibration support 41 into the optical channel 132, the flexible light-shielding portion 31 is elastically deformed and retained between the outer perimeter of the tubular calibration support 41 and the inner perimeter of the optical channel 132 to hold down the tubular calibration support 41 in the optical channel 132, thus, the fiber optic core 421 in the tubular calibration support 41 is kept in axial alignment with the light source transceiver 21 of the optical device 2 for allowing transmission of signals between the light source transceiver 21 and the fiber optic core 421, and the communication between the light source transceiver 21 and the fiber optic core 421 is shielded by the light-shielding device 3 against external interference. Further, the deformed flexible light-shielding portion 31 prohibits external dust from entering with the tubular calibration support 41 into the optical channel 132.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A light-shielding fiber optic connector, comprising:
a housing comprising a mating-connection chamber, a mating-connection portion located at one side of said mating-connection chamber, an accommodation chamber located at an opposite side of said mating-connection chamber and a plug hole perpendicularly connected to said mating-connection chamber near said accommodation chamber;
an optical device mounted in said accommodation chamber, said optical device comprising a light source transceiver facing toward said mating-connection chamber and a plurality of electrical pins extended out of said housing for bonding to an external circuit board;
a light-shielding device mounted in said plug hole of said housing, said light-shielding device comprising a flexible light-shielding portion for blocking between said mating-connection chamber and said accommodation chamber; and
a position-limiting member mounted to said housing to hold down said light-shielding device in said plug hole.

2. The light-shielding fiber optic connector as claimed in claim 1, wherein said housing further comprises a connecting bush axially mounted therein in communication between said plug hole and said mating-connection chamber, a docking channel defined in said connecting bush in communication between said mating-connection chamber and said accommodation chamber, and an optical channel of reduced diameter disposed in communication between said docking channel and said accommodation chamber.

3. The light-shielding fiber optic connector as claimed in claim 2, wherein the inserted length of said connecting bush in said mating-connection chamber is smaller or equal to one half of the length of said mating-connection chamber; the diameter of said optical channel is smaller than or equal to the width of said optical device and greater than or equal to the size of said light source transceiver.

4. The light-shielding fiber optic connector as claimed in claim 2, wherein the diameter of said docking channel is smaller than or equal to the width of said flexible light-shielding portion of said light-shielding device; the diameter of said optical channel is smaller than or equal to the width of said flexible light-shielding portion of said light-shielding device.

5. The light-shielding fiber optic connector as claimed in claim 1, further comprising fastening means for fastening said position-limiting member to said housing, wherein said housing further comprises an external locating groove extended around the periphery thereof over said plug hole for the mounting of said position-limiting member; said fastening means comprises a plurality of hook blocks symmetrically protruded from two opposite lateral sides of the periphery of said housing within said external locating groove, and a plurality of hook holes symmetrically located on two opposite lateral sides of said position-limiting member for engagement with the respective said hook blocks.

6. The light-shielding fiber optic connector as claimed in claim 1, further comprising an engagement structure for securing said light-shielding device to said housing, said engagement structure comprising a plurality of engagement grooves vertically and symmetrically located on two opposite inner sidewalls of said plug hole, and a plurality of engagement rails vertically and symmetrically located on two opposite sides of said light-shielding device for engaging into the respective said engagement grooves.

7. The light-shielding fiber optic connector as claimed in claim 1, wherein said housing further comprises at least one rib located on an inside wall of said accommodation chamber for abutment against the inserted said optical device, and a guiding channel cut through a bottom wall thereof in communication with said accommodation chamber for the passing of said electrical pins of said optical device to the outside of said housing.

8. The light-shielding fiber optic connector as claimed in claim 1, wherein said light-shielding device is selectively made of plastic, silicone or rubber; said flexible light-shielding portion is selectively made of opaque flexible plastic, silicon rubber or rubber in a width smaller than the width of said light-shielding device.

9. The light-shielding fiber optic connector as claimed in claim 8, wherein said flexible light-shielding portion is integrally formed in said light-shielding device in a crossed shape, star shape or radial configuration and extended through two opposite sides of said light-shielding device so that said light-shielding device is elastically deformable in different directions
